(19) United States
(12) Patent Application Publication
(10) Pub. No.: US 2023/0177140 A1
(43) Pub. Date: Jun. 8, 2023

(54) INFORMATION PROCESSING DEVICE AND DETERMINATION METHOD

(71) Applicant: Panasonic Intellectual Property Management Co., Ltd., Osaka (JP)

(72) Inventors: Hitoshi ONO, Tokyo (JP); Yoshiharu IMAMOTO, Kanagawa (JP); Kento TAMURA, Osaka (JP)

(73) Assignee: Panasonic Intellectual Property Management Co., Ltd., Osaka (JP)

(21) Appl. No.: 18/070,221

(22) Filed: Nov. 28, 2022

(30) Foreign Application Priority Data
Dec. 8, 2021 (JP) 2021-198989

(51) Int. Cl. G06F 21/44

(52) U.S. Cl. CPC G06F 21/44

(57) ABSTRACT

An information processing device includes: a guest OS; a host OS that accesses a sector group stored in an external storage device in response to an access request from the guest OS; a virtualization control system that is executed on a hardware and controls execution of the guest OS and the host OS. The host OS includes: a back-end device driver that obtains the access request from the guest OS; and a sector group access determiner that determines whether or not the access request is anomalous, based on a sector group access rule database indicating a rule for accessing the sector group stored in the external storage device.

### CROSS REFERENCE TO RELATED APPLICATION

The present application is based on and claims priority of Japanese Patent Application No. 2021-198989 filed on Dec. 8, 2021.

### FIELD

The present disclosure relates to an information processing device and a determination method.

### BACKGROUND

Information processing devices including a service operating system (referred to as a service OS hereinafter), a security operating system (referred to as a security OS hereinafter), and a control program that control execution of the service OS and the security OS are known (see PTL 1, for example).

The service OS hooks(obtains) an access request from a server program to a magnetic disk, and requests the security OS to determine the authenticity of the hooked access request. When the security OS determines that the access request from the server program is anomalous, the service OS generates an error code based on the determination result from the security OS.

On the other hand, when the security OS determines that the access request from the server program is not anomalous, the service OS performs access to the magnetic disk based on the access request from the server program, based on the determination result from the security OS.

### CITATION LIST

### Patent Literature

PTL 1: Japanese Patent No. 4177957

### SUMMARY

However, the conventional information processing devices described above can be improved upon.

In view of this, the present disclosure provides an information processing device and a determination method that are capable of improving upon the above related art.

In accordance with an aspect of the present disclosure, an information processing device that determines an anomalous access to a vehicle includes: a first operating system; a second operating system that accesses a sector group stored in a storage device, in response to an access request from the first operating system; and a virtualization control system that is executed on a processor and controls execution of the first operating system and the second operating system, wherein the second operating system includes: an obtainer that obtains the access request from the first operating system; and a determiner that determines whether or not the access request is anomalous, based on rule information indicating a rule for accessing the sector group stored in the storage device.

In this specification, the sector group means information that describes a file itself or information on a file (such as i-node information of Linux(registered trademark)) or information on a file system. The sector group name means file name indicating a file itself or a specific name (such as a designation by a directory name) of information on a file. Information on a file means meta information including file name, file size, access permission, change history, or information required for an access control system.

It should be noted that general or specific aspects of the present disclosure may be implemented to a system, a method, an integrated circuit, a computer program, a non-transitory computer-readable recording medium such as a Compact Disc-Read Only Memory (CD-ROM), or any given combination thereof.

With the information processing device according to an aspect of the present disclosure and the like are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating a configuration of an information processing device according to an embodiment.

FIG. 2 is a diagram illustrating an example of a device access log according to the embodiment.

FIG. 3 is a diagram illustrating an example of a sector group database according to the embodiment.

FIG. 4 is a diagram illustrating an example of a sector group access log according to the embodiment.

FIG. 5 is a diagram illustrating an example of sector group access information according to the embodiment.

FIG. 6 is a diagram illustrating an example of a sector group access rule database according to the embodiment.

FIG. 7 is a flowchart illustrating a flow of a general operation of a host OS according to the embodiment.

FIG. 8 is a flowchart illustrating a flow of an operation of an access log analyzer according to the embodiment.

FIG. 9 is a flowchart illustrating a flow of an operation of a sector group access determiner according to the embodiment.

FIG. 10 is a flowchart specifically illustrating the process in step S305 in the flowchart of FIG. 9.

FIG. 11 is a flowchart specifically illustrating the process in step S305 in the flowchart of FIG. 9.

FIG. 12 is a flowchart illustrating Example 1 of a determination method for a behavior using an N-th behavior rule.

FIG. 13 is a flowchart illustrating Example 2 of the determination method for a behavior using the N-th behavior rule.

FIG. 14 is a flowchart illustrating Example 3 of the determination method for a behavior using the N-th behavior rule.

FIG. 15 is a flowchart illustrating Example 4 of the determination method for a behavior using the N-th behavior rule.

FIG. 16 is a flowchart illustrating Example 5 of the determination method for a behavior using the N-th behavior rule.

FIG. 17 is a flowchart illustrating Example 6 of the determination method for a behavior using the N-th behavior rule.

FIG. 18 is a flowchart illustrating Example 7 of the determination method for a behavior using the N-th behavior rule.

FIG. 19 is a flowchart illustrating Example 8 of the determination method for a behavior using the N-th behavior rule.

### DESCRIPTION OF EMBODIMENT

(Observation under which the present disclosure has been made)

The inventors of the present disclosure have found the following problem in the information processing devices described in “Background”.

With the conventional information processing devices described previously, when the service OS itself is attacked by a malicious program, the function of hooking the access request from the server program or the like may be disabled. This poses a problem that the security OS cannot precisely determine the authenticity of the access request from the server program.

In order to solve such a problem, in accordance with an aspect of the present disclosure, an information processing device that determines an anomalous access to a vehicle includes: a first operating system; a second operating system that accesses a sector group stored in a storage device, in response to an access request from the first operating system; and a virtualization control system that is executed on a processor and controls execution of the first operating system and the second operating system, wherein the second operating system includes: an obtainer that obtains the access request from the first operating system; and a determiner that determines whether or not the access request is anomalous, based on rule information indicating a rule for accessing the sector group stored in the storage device.

Here, virtualization control system refers to a system that receives I/O information of an operating system running on a virtualization system via a hypervisor and exchanges the I/O information with an actual device.

According to this aspect, the second operating system determines the authenticity of an access request from the first operating system by hooking(obtaining) the access request and analyzing the hooked access request. Therefore, even when the security function of the first operating system is disabled or tampered by a malicious computer program, for example, the second operating system can use the hooked access request as information for monitoring any anomaly in the first operating system, and therefore can precisely determine the authenticity of the access request from the first operating system.

For example, it is possible that the second operating system further includes an analyzer that generates, from the access request including (i) a sector number and (ii) a sector group name of the sector group stored in a storage area corresponding to the sector number in the storage device, access log information indicating the sector number and the sector group name in association with each other, with reference to correspondence information indicating a correspondence between the sector number and the sector group name, and the determiner determines whether or not the access request is anomalous, based on the rule information and the access log information.

According to this aspect, even when the access request includes no sector group name, access log information including a sector group name can be generated from the access request by referring to the correspondence information. Therefore, whether or not the access request is anomalous can be easily determined based on the rule information and the access log information.

For example, it is possible that the second operating system further includes a handler that sends, to an outside, a notification indicating a result of the determination made by the determiner, when the determiner determines that the access request is anomalous.

According to this aspect, when a malicious computer program is executed on the first operating system, for example, the first operating system can be appropriately handled.

For example, it is possible that when the determiner determines that the access request is anomalous, the handler sends the notification to the outside and stops an access to the sector group stored in the storage device.

According to this aspect, when a malicious computer program is executed on the first operating system, for example, the sector group stored in the storage device can be appropriately protected.

For example, it is possible that the rule information includes, as the rule, at least one of a process or an operation in which access to the sector group stored in the storage device is permitted.

According to this aspect, the authenticity of the access request from the first operating system can be easily determined by determining, based on the rule information, whether or not the process and/or operation according to the access request is a permitted process and/or operation.

For example, it is possible that the determiner determines whether or not the access request is anomalous, based on the rule information on reading and writing authority for reading and writing the sector group.

According to this aspect, the determiner can determine whether or not the access request is anomalous by considering the reading and writing authority for reading and writing the sector group.

For example, it is possible that the second operating system is accessible to an external device, and that the determiner determines whether or not the access request is anomalous, based on the rule information and a state of the external device.

According to this aspect, the determiner can determine whether or not the access request is anomalous by considering the state of the external device.

For example, it is possible that the determiner determines whether or not the access request is anomalous, based on the rule information and a state of the information processing device.

According to this aspect, the determiner can determine whether or not the access request is anomalous by considering the state of the information processing device.

For example, it is possible that the determiner determines whether or not the access request is anomalous, based on the rule information and a state of the sector group.

According to this aspect, the determiner can determine whether or not the access request is anomalous by considering the state of the sector group.

For example, it is possible that the determiner determines whether or not the access request is anomalous, based on the rule information and an access content of an access to the sector group to which writing is permitted.

According to this aspect, the determiner can determine whether or not the access request is anomalous by considering the content of the access to the sector group to which a write is permitted.

In accordance with another aspect of the present disclosure, a determination method is a method of determining an anomalous access to a vehicle, by using an information processing device. The information processing device includes: a first operating system; a second operating system that accesses a sector group stored in a storage device, in response to an access request from the first operating system; and a virtualization control system that is executed on a processor and controls execution of the first operating system and the second operating system. The determination method includes: obtaining, by the second operating system, the access request from the first operating system; determining whether or not the access request obtained in the obtaining is anomalous, based on rule information indicating a rule for accessing the sector group stored in the storage device; and outputting, to an outside, a result of the determining when the access request is determined to be anomalous.

According to this aspect, the second operating system determines the authenticity of an access request from the first operating system by hooking the access request and analyzing the hooked access request. Therefore, even when the security function of the first operating system is disabled or tampered by a malicious computer program, for example, the second operating system can use the hooked access request as information for monitoring any anomaly in the first operating system, and therefore can precisely determine the authenticity of the access request from the first operating system.

It should be noted that general or specific aspects of the present disclosure may be implemented to a system, a method, an integrated circuit, a computer program, a non-transitory computer-readable recording medium such as a Compact Disc-Read Only Memory (CD-ROM), or any given combination thereof.

Hereinafter, certain exemplary embodiments will be described in detail with reference to the accompanying Drawings.

The following embodiments are general or specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements.

### Embodiment

[1. Configuration of Information Processing Device]

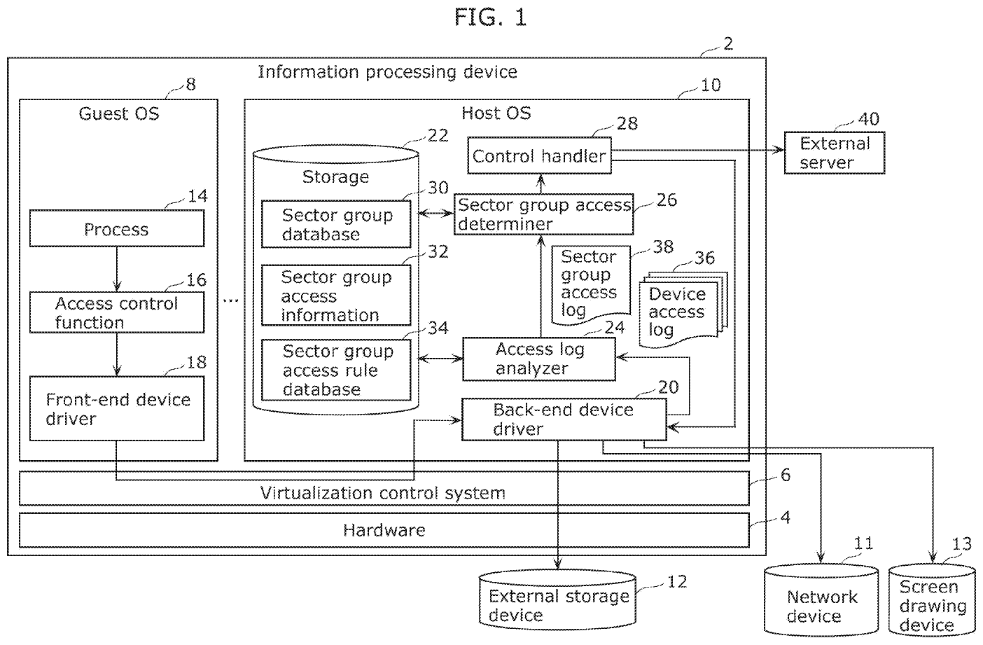

First, a configuration of information processing device 2 according to an embodiment will be described with reference to FIG. 1 to FIG. 6. FIG. 1 is a block diagram illustrating a configuration of information processing device 2 according to the embodiment. FIG.

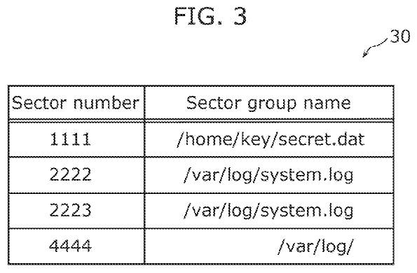

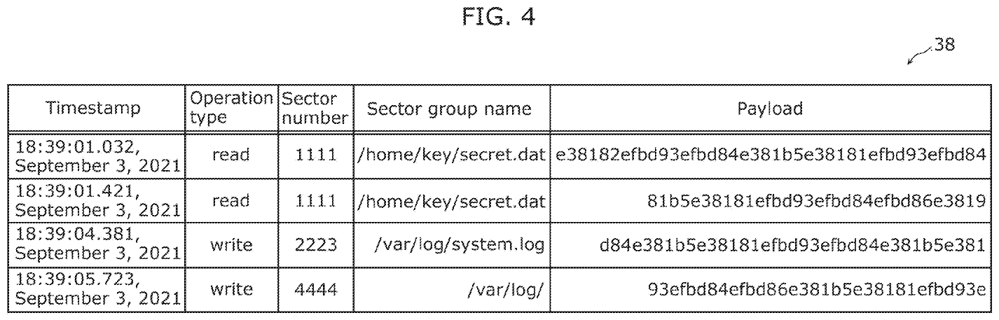

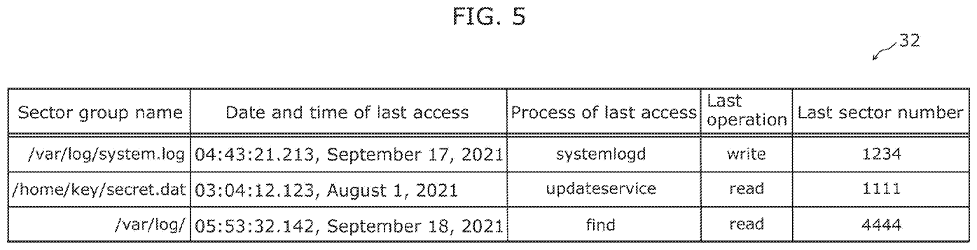

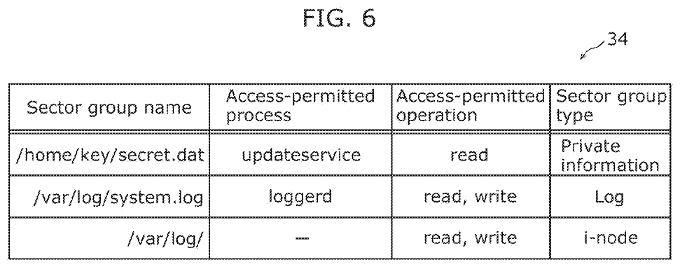

2 is a diagram illustrating an example of device access log 36 according to the embodiment. FIG. 3 is a diagram illustrating an example of sector group database 30 according to the embodiment. FIG. 4 is a diagram illustrating an example of sector group access log 38 according to the embodiment. FIG. 5 is a diagram illustrating an example of sector group access information 32 according to the embodiment. FIG. 6 is a diagram illustrating an example of sector group access rule database 34 according to the embodiment.

As illustrated in FIG. 1, information processing device 2 according to the embodiment includes hardware 4, virtualization control system 6, a plurality of guest operating systems 8 (referred to as guest OS 8 hereinafter), and host operating system 10 (referred to as host OS 10 hereinafter) running on virtualization control system 6. Information processing device 2 is a device for determining an anomalous access to a vehicle, such as an automobile, for example.

External storage device 12 is electrically connected to information processing device 2. External storage device 12 is an example of storage devices and is constituted by a hard disk drive (HDD), for example. External storage device 12 has a plurality of storage areas for storing a sector group (data). A plurality of sector numbers is assigned to each of the plurality of storage areas. The sector number allows host OS 10, when accessing a sector group stored in external storage device 12 in response to an access request from guest OS 8 as described later, to specify a storage area in external storage device 12 storing the sector group, and is formed by 4 digits, for example.

In this specification, the sector group means information that describes a file itself or information on a file (such as i-node information of Linux) or information on a file system. The sector group name means file name indicating a file itself or a specific name (such as a designation by a directory name) of information on a file. Information on a file means meta information including file name, file size, access permission, change history, or information required for an access control system.

Network device 11 and screen drawing device 13 are also electrically connected to information processing device 2. Network device 11 and screen drawing device 13 are each an example of external devices.

Hardware 4 includes a processor having a central processing unit (CPU) or an electronic control unit (ECU), for example, and provides an execution environment for a plurality of computer programs. Hardware 4 may be formed by a single processor or a plurality of processors.

Virtualization control system 6 is virtualization software that is executed on hardware 4 (processor) and controls execution of the plurality of guest OSs 8 and host OS 10. Virtualization control system 6 allows virtualization and installation of a plurality of different OSs (the plurality of guest OSs 8 and host OS 10) on one piece of hardware 4. In this embodiment, virtualization control system 6 is a hypervisor commonly called Type 1 (bare-metal).

Each of the plurality of guest OSs 8 is a virtual machine (VM) of Linux or the like running on virtualization control system 6, and is an example of a first operating system. Each of the plurality of guest OSs 8 has a plurality of processes 14, access control function 16, and front-end device driver 18. In FIG. 1, for the convenience of explanation, only one guest OS 8 is illustrated. Although the plurality of guest OSs 8 runs on virtualization control system 6 in the configuration according to this embodiment, the present disclosure is not limited to this, and only one guest OS 8 may run on virtualization control system 6.

Each of the plurality of processes 14 is a computer program for executing various functions of guest OS 8. To execute various functions of guest OS 8, each of the plurality of processes 14 generates an access request for requesting access to a sector group (such as writing to a sector group or reading of a sector group) stored in external storage device 12. In FIG. 1, for the convenience of explanation, only one process 14 is illustrated.

Access control function 16 is a security function for monitoring an access request generated by each of the plurality of processes 14.

For example, when a malicious computer program, such as malware, is executed on guest OS 8 and attempts to anomalously access a sector group stored in external storage device 12, access control function 16 discards the access request generated by the malicious computer program.

Front-end device driver 18 is a virtual device driver (VirtlO) for driving a virtual network interface formed in guest OS 8. Front-end device driver 18 transmits, to back-end device driver 20 (described later) of host OS 10 via virtualization control system 6, an access request generated by each of the plurality of processes 14.

Front-end device driver 18 also receives, via virtualization control system 6, an access request (described later) from back-end device driver 20 of host OS 10.

Host OS 10 is a virtual machine of Linux or the like running on virtualization control system 6, and is an example of a second operating system. Here, virtualization control system refers to a system that receives I/O information of guest OSs 8 running on the virtualization system via a hypervisor and exchanges the I/O information with actual external storage device 12. Host OS 10 has back-end device driver 20, storage 22, access log analyzer 24, sector group access determiner 26, and control handler 28.

Back-end device driver 20 is a virtual device driver (VirtlO) for driving a virtual network interface formed in host OS 10, and is an example of an obtainer. Back-end device driver 20 obtains (receives) an access request from front-end device driver 18 of guest

OS 8 via virtualization control system 6, and outputs the obtained access request to access log analyzer 24.

When sector group access determiner 26 determines that the access request is not anomalous as described later, back-end device driver 20 accesses a sector group stored in external storage device 12 in response to the access request. In this case, back-end device driver 20 transmits, to front-end device driver 18 of guest OS 8 via virtualization control system 6, an access response that indicates the result of the access to the sector group stored in external storage device 12. Furthermore, back-end device driver 20 can access each of network device 11 and screen drawing device 13.

Storage 22 is a memory that stores sector group database 30, sector group access information 32, and sector group access rule database 34. Sector group database 30, sector group access information 32, and sector group access rule database 34 will be described later.

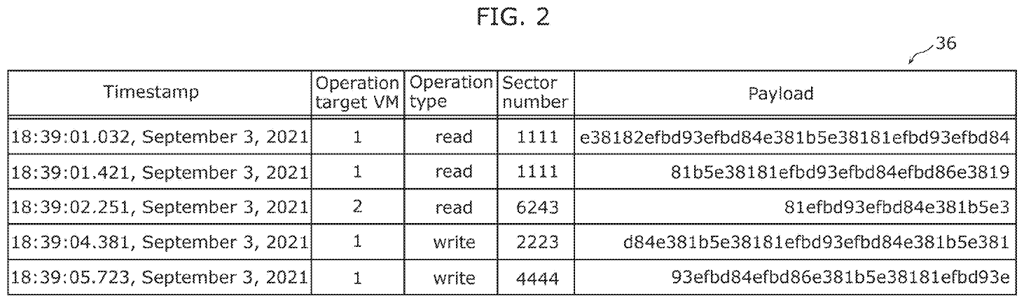

Access log analyzer 24 is an example of an analyzer, and obtains device access log 36 as a log of access requests obtained by back-end device driver 20. Here, device access log 36 is a database in a table format such as one illustrated in FIG. 2. As illustrated in

FIG. 2, in device access log 36, a timestamp, an operation target VM, an operation type, a sector number, and a payload are associated with each other. The timestamp is information indicating the date and time when front-end device driver 18 of guest OS 8 transmitted the access request. The operation target VM is information indicating guest OS 8 that is the transmission source of the access request, and is a serial number, such as 1, 2, . . . , n, assigned to each of the plurality of guest OSs 8, for example. The operation type is information indicating the type of the operation to the sector group according to the access request, such as read (reading of the sector group) or write (writing to the sector group). The sector number is information for specifying a storage area for the sector group in external storage device 12. The payload is information indicating the content of the operation request (such as information about what kind of content is to be written).

In the example illustrated in FIG. 2, in the first row in device access log 36, a) a timestamp “18:39:01.032, September 3, 2021”, b) an operation target VM “1”, c) an operation type “read”, d) a sector number “1111”, and e) a payload “e38182...” are stored. That is, the first row in device access log 36 means that guest OS 8 assigned with the number “1” transmitted an access request for reading (“read”) the sector group stored in the storage area in external storage device 12 corresponding to the sector number “1111” at the date and time of “18:39:01.032, September 3, 2021”.

In addition, access log analyzer 24 generates sector group access log 38 from device access log 36 based on sector group database 30 stored in storage 22. Here, sector group database 30 is a database in a table format such as one illustrated in FIG. 3, and is an example of correspondence information. As illustrated in FIG. 3, sector group database 30 is a database that indicates a correspondence between a sector number and a sector group name of a sector group stored in a storage area of external storage device 12 that corresponds to the sector number. Sector group database 30 is generated at the first activation of information processing device 2, for example.

In the example illustrated in FIG. 3, in the first row in sector group database 30, a) a sector number “1111”, and b) a sector group name “/home/key/secret.dat” are stored. That is, the first row in sector group database 30 means that a storage area in external storage device 12 that corresponds to the sector number “1111” stores a sector group having the sector group name “/home/key/secret.dat”. When the log of access request increases, and a sector number is added, sector group database 30 is updated.

Access log analyzer 24 first extracts only a log relating to guest OS 8 (guest OS 8 assigned with a number “1”, for example) that is a target of monitoring from device access log 36. Access log analyzer 24 then generates sector group access log 38 by associating a sector number included in the log extracted from device access log 36 and a sector group name corresponding to the sector number. Access log analyzer 24 outputs the generated sector group access log 38 to sector group access determiner 26.

Here, sector group access log 38 is a database in a table format such as one illustrated in FIG. 4. As illustrated in FIG. 4, in sector group access log 38, a timestamp, an operation type, a sector number, a sector group name, and a payload are associated with each other.

In the example illustrated in FIG. 4, in the first row in sector group access log 38, a) a timestamp “18:39:01.032, September 3, 2021”, b) an operation type “read”, c) a sector number “1111”, d) a sector group name “/home/key/secret.dat”, and e) a payload “e38182. . . ” are stored. That is, the first row in sector group access log 38 means that guest OS 8 assigned with the number “1” transmitted an access request for reading (“read”) the sector group having the sector group name “/home/key/secret.dat” stored in the storage area in external storage device 12 corresponding to the sector number “1111” at the date and time of “18:39:01.032, September 3, 2021”.

In addition, access log analyzer 24 updates sector group access information 32 stored in storage 22 based on the generated sector group access log 38. Here, sector group access information 32 is a database in a table format such as one illustrated in FIG. 5. As illustrated in FIG. 5, in sector group access information 32, a sector group name, a date and time of last access, a process of last access, a last operation, and a last sector number are associated with each other.

In the example illustrated in FIG. 5, a) sector group name “/var/log/system.log”, b) a date and time of last access “04:43:21.213, September 17, 2021”, c) a process of last access “systemlogd”, d) a last operation “write”, and e) a last sector number “1234” are stored. That is, the first row in sector group access information 32 means that the last access to the sector group having the sector group name “/var/log/system.log” is writing of a sector group to the storage area in external storage device 12 corresponding to the sector number “1234” by the process “systemlogd” at the date and time of “04:43:21.213, September 17, 2021”

Sector group access determiner 26 is an example of a determiner, and determines whether or not the access request from guest OS 8 is anomalous based on sector group access information 32 and sector group access rule database 34 stored in storage 22 and sector group access log 38.

Here, sector group access rule database 34 is a database that indicates a correspondence between the sector group name of each sector group stored in external storage device 12 and a rule for accessing the sector group. Specifically, sector group access rule database 34 is a database in a table format such as one illustrated in FIG. 6, and an example of rule information. As illustrated in FIG. 6, in sector group access rule database 34, a sector group name, an access-permitted process, an access-permitted operation, and a sector group type are associated with each other. The access-permitted process is information (rule) indicating a process that is permitted to access the sector group. The access-permitted operation is information (rule) indicating an operation that is permitted to access the sector group. The sector group type is information indicating the type of the sector group (private information or log).

In the example illustrated in FIG. 6, in the first row in sector group access rule database 34, a) sector group name “/home/key/secret.dat”, b) an access-permitted process “updateservice”, c) an access-permitted operation “read”, and d) a sector group type “private information” are stored. That is, the first row in sector group access rule database 34 means that the process and the operation permitted to access the sector group having the sector group name “/home/key/secret.dat” including “private information” are “updateservice” and “read”, respectively.

Although sector group access rule database 34 includes a process and an operation permitted to access the sector group as rules for accessing the sector group stored in external storage device 12, the present disclosure is not limited to this, and sector group access rule database 34 may include only one of the process and the operation.

Sector group access determiner 26 determines whether or not the process and operation attempting to access the sector group stored in external storage device 12 conform to the rules defined by sector group access rule database 34 by comparing sector group access rule database 34 and sector group access log 38. Sector group access determiner 26 also determines whether or not a behavior of the access to the sector group by guest OS 8 is a permitted behavior by comparing sector group access information 32 and sector group access log 38. Sector group access determiner 26 outputs the determination result to control handler 28

The permitted behavior may be a) an operation of appending to a log file (a sector group indicating a log) or b) an operation of reading a sector group at the first activation of information processing device 2, for example. With the former operation, in general, even when writing to a log file is authorized, the only operation that can occur is appending to the log file, and therefore an operation of modifying or erasing a part of the log file can be determined to be an anomalous access. With the latter operation, in general, a sector group indicating a policy or the like of access control function 16 of guest OS 8 is read only at the first activation of information processing device 2, and therefore an operation of reading the sector group when a considerable length of time has elapsed since the first activation can be determined to be an anomalous access.

In addition, sector group access determiner 26 can obtain information relating to information processing device 2, such as information indicating the time of activation of information processing device 2 and information indicating an activation mode of information processing device 2, for example. The activation mode of information processing device 2 is a normal mode or a repro mode.

Control handler 28 is an example of a handler, and controls handling based on the determination result from sector group access determiner 26. Specifically, when sector group access determiner 26 determines that the access request is anomalous, control handler 28 sends an error notification to external server 40 having a security information and event management (SIEM) function, for example. When sector group access determiner 26 determines that the access request is not anomalous, control handler 28 instructs back-end device driver 20 to access the sector group stored in external storage device 12 according to the access request.

[2. Operation of Information Processing Device]

[2-1. General Operation of Host OS]

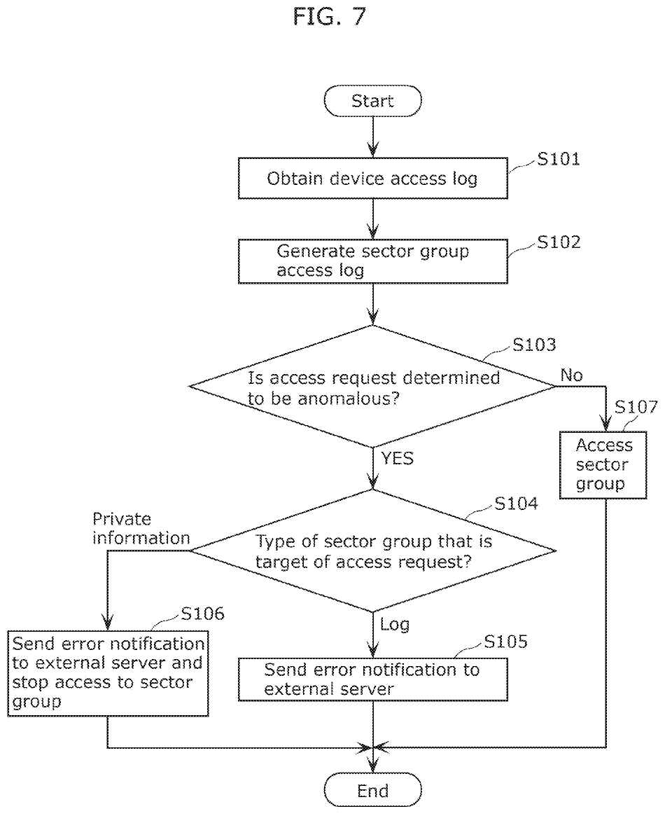

With reference to FIG. 7, a general operation of host OS 10 according to the embodiment will be described. FIG. 7 is a flowchart illustrating a flow of the general operation of host OS 10 according to the embodiment.

As illustrated in FIG. 7, access log analyzer 24 first obtains device access log 36 as a log of access requests obtained by back-end device driver 20 (S101).

Access log analyzer 24 then extracts only a log relating to guest OS 8 that is the target of monitoring from device access log 36, and generates sector group access log 38 by associating a sector number included in the extracted log and a sector group name corresponding to the sector number by referring to sector group database 30 stored in storage 22 (S102).

Sector group access determiner 26 then determines whether or not the access request from guest OS 8 is anomalous based on sector group access information 32 and sector group access rule database 34 stored in storage 22 and sector group access log 38 (S103). Sector group access determiner 26 outputs the determination result to control handler 28.

When sector group access determiner 26 determines that the access request is anomalous (YES in S103), control handler 28 determines the type of the sector group that is the target of the access request based on the sector group name included in sector group access log 38 (S104).

When the type of the sector group is “log” (“log” in S104), control handler 28 sends an error notification to external server 40 (S105). In this case, the timing when control handler 28 sends the error notification to external server 40 is a timing that comes at regular intervals determined in advance (a timing that comes every five minutes, for example). Then, sector group access determiner 26 erases the content relating to the anomalous access request in sector group access information 32. After that, the process of the flowchart of FIG. 7 ends.

On the other hand, when the type of the sector group is “private information” (“private information” in S104), control handler 28 sends an error notification to external server 40 and instructs back-end device driver 20 to stop the access to the sector group according to the access request (S106). In this case, the timing when control handler 28 sends the error notification and stops the access to the sector group is an immediate timing. When sending the error notification to external server 40, control handler 28 may additionally notify external server 40 of sector group access log 38 determined to be anomalous. Then, sector group access determiner 26 erases the content relating to the anomalous access request in sector group access information 32. After that, the process of the flowchart of FIG. 7 ends.

Referring back to step S103, when sector group access determiner 26 determines that the access request is not anomalous (NO in S103), control handler 28 instructs back-end device driver 20 to access the sector group stored in external storage device 12 according to the access request (S107). Then sector group access determiner 26 updates sector group access information 32 based on the content of the access request. After that, the process of the flowchart of FIG. 7 ends.

[2-2. Operation of Access Log Analyzer]

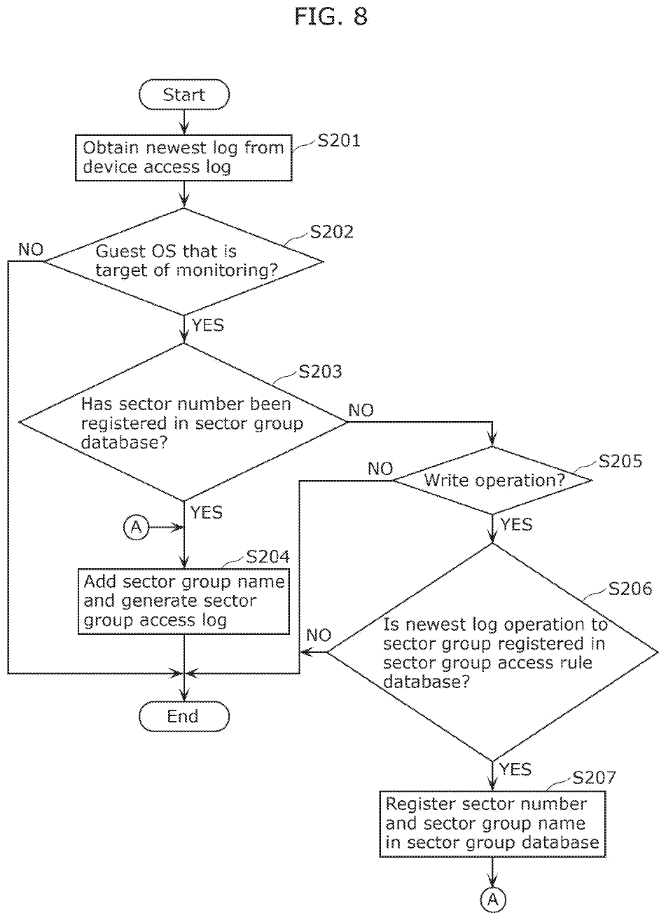

With reference to FIG. 8, an operation of access log analyzer 24 will be specifically described. FIG. 8 is a flowchart illustrating a flow of the operation of access log analyzer 24 according to the embodiment.

As illustrated in FIG. 8, access log analyzer 24 first obtains the newest log from device access log 36 (S201). Access log analyzer 24 then determines whether or not the operation target VM included in the obtained newest log is guest OS 8 that is the target of monitoring (S202). When the operation target VM included in the obtained newest log is not guest OS 8 that is the target of monitoring (NO in S202), the process of the flowchart of FIG. 8 ends.

On the other hand, when the operation target VM included in the obtained newest log is guest OS 8 that is the target of monitoring (YES in S202), access log analyzer 24 determines whether or not the sector number included in the obtained newest log has been registered in sector group database 30 (S203).

When the sector number included in the obtained newest log has been registered in sector group database 30 (YES in S203), access log analyzer 24 generates sector group access log 38 by associating the sector number included in the obtained newest log and the sector group name corresponding to the sector number registered in sector group database 30 (S204). After that, the process of the flowchart of FIG. 8 ends.

On the other hand, when the sector number included in the obtained newest log has not been registered in sector group database 30 (NO in S203), access log analyzer 24 determines whether or not the operation type included in the obtained newest log is “write” (S205). When the operation type included in the obtained newest log is not “write” (NO in S205), the process of the flowchart of FIG. 8 ends.

On the other hand, when the operation type included in the obtained newest log is “write” (YES in S205), access log analyzer 24 determines whether or not the obtained newest log is an operation to the sector group registered in sector group access rule database 34 (S206). When the obtained newest log is not an operation to the sector group registered in sector group access rule database 34 (NO in S206), the process of the flowchart of FIG. 8 ends.

On the other hand, when the obtained newest log is an operation to the sector group registered in sector group access rule database 34 (YES in S206), access log analyzer 24 registers the sector number and the sector group name corresponding to the sector number in sector group database 30 (S207), and proceeds to step S204.

[2-3. Operation of Sector Group Access Determiner]

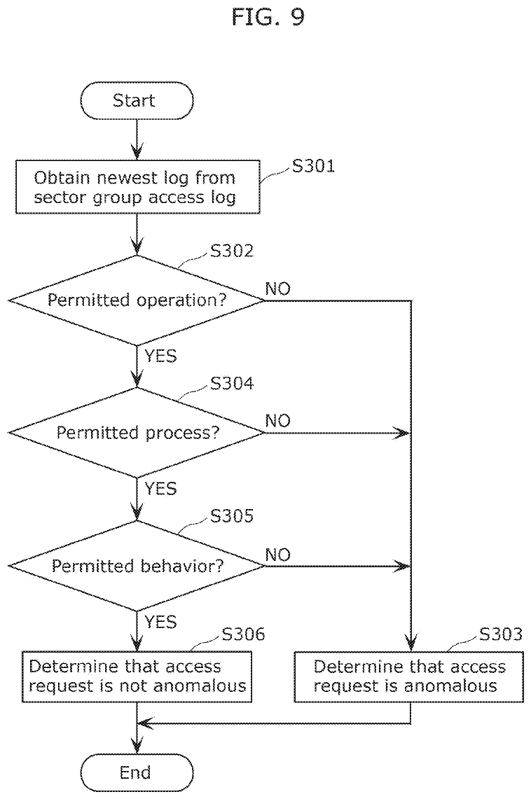

With reference to FIG. 9, an operation of sector group access determiner 26 will be specifically described. FIG. 9 is a flowchart illustrating a flow of the operation of sector group access determiner 26 according to the embodiment.

As illustrated in FIG. 9, sector group access determiner 26 first obtains the newest log from sector group access log 38 (S301). Sector group access determiner 26 then determines whether or not the operation type included in the obtained newest log is an access-permitted operation for the sector group name in the newest log included in sector group access rule database 34 (S302). That is, sector group access determiner 26 determines whether or not the access request is anomalous base on the rule information concerning the reading and writing authority for reading and writing the sector group. When the operation type included in the obtained newest log is not an access-permitted operation (NO in S302), sector group access determiner 26 determines that the access request from guest OS 8 is anomalous (S303). After that, the process of the flowchart of FIG. 9 ends.

On the other hand, when the operation type included in the obtained newest log is an access-permitted operation (YES in S302), sector group access determiner 26 determines whether or not the process is an access-permitted process for the sector group name in the newest log included in sector group access rule database 34 (S304). When the process is no an access-permitted process (NO in S304), sector group access determiner 26 determines that the access request from guest OS 8 is anomalous (S303). After that, the process of the flowchart of FIG. 9 ends.

On the other hand, when the access is an access-permitted process (YES in S304), sector group access determiner 26 determines, based on sector group access information 32, whether or not the behavior of the access to the sector group stored in external storage device 12 is a permitted behavior (S305). When the behavior is not a permitted behavior (NO in S305), sector group access determiner 26 determines that the access request from guest OS 8 is anomalous (S303). After that, the process of the flowchart of FIG. 9 ends.

On the other hand, when the behavior is a permitted behavior (YES in S305), sector group access determiner 26 determines that the access request from guest OS 8 is not anomalous (S306). After that, the process of the flowchart of FIG. 9 ends.

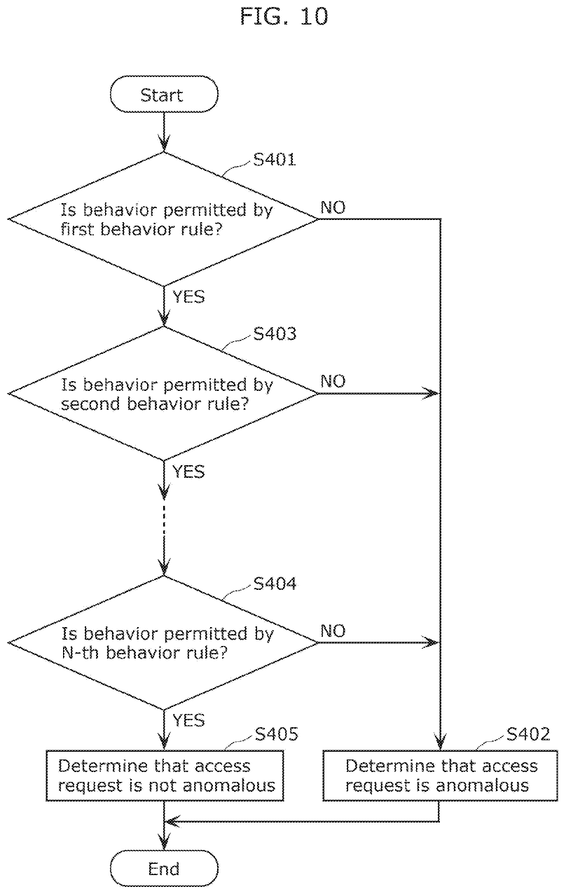

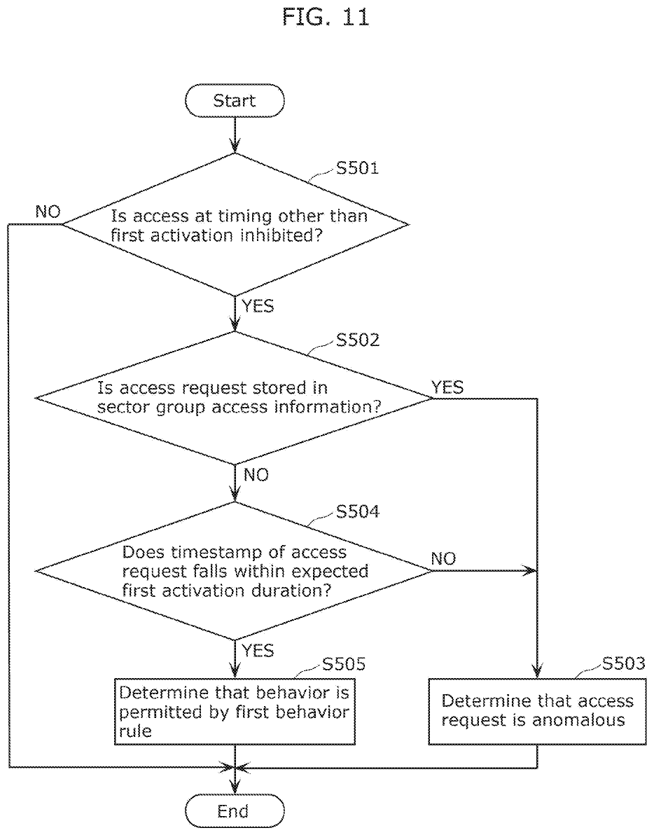

Here, with reference to FIG. 10 and FIG. 11, the process in step S305 in the flowchart of FIG. 9 will be specifically described. FIG. 10 and FIG. 11 are flowcharts specifically illustrating the process in step S305 in the flowchart of FIG. 9.

Based on a first behavior rule to an N-th behavior rule, sector group access determiner 26 determines whether or not the behavior is a behavior permitted by each of the first behavior rule to the N-th behavior rule.

As illustrated in FIG. 10, in the other cases than the cases described above, sector group access determiner 26 determines whether or not the behavior is a behavior permitted by the first behavior rule (S401). When the behavior is not a behavior permitted by the first behavior rule (NO in S401), sector group access determiner 26 determines that the access request from guest OS 8 is anomalous (S402). After that, the process of the flowchart of FIG. 10 ends.

On the other hand, when the behavior is a behavior permitted by the first behavior rule (YES in S401), sector group access determiner 26 determines whether or not the behavior is a behavior permitted by a second behavior rule (S403). When the behavior is not a behavior permitted by the second behavior rule (NO in S403), sector group access determiner 26 determines that the access request from guest OS 8 is anomalous (S402). After that, the process of the flowchart of FIG. 10 ends.

After the behavior is a behavior permitted by the second behavior rule (YES in S403), sector group access determiner 26 performs similar determinations until sector group access determiner 26 determines whether or not the behavior is a behavior permitted by the N-th second behavior rule (S404). When the behavior is not a behavior permitted by the N-th behavior rule (NO in S404), sector group access determiner 26 determines that the access request from guest OS 8 is anomalous (S402). After that, the process of the flowchart of FIG. 10 ends.

When the behavior is a behavior permitted by the N-th behavior rule (YES in S404), sector group access determiner 26 determines that the access request from guest OS 8 is not anomalous (S405). After that the process of the flowchart of FIG. 10 ends. Next, with reference to FIG. 11, a determination method for a behavior using the first behavior rule will be described. The first behavior rule is a rule concerning a behavior of an access to a sector group at the first activation of information processing device 2, for example.

As illustrated in FIG. 11, when an access to a sector group at a timing other than the first activation of information processing device 2 is not inhibited (NO in S501), the process of the flowchart of FIG. 11 ends. On the other hand, when an access to a sector group at a timing other than the first activation of information processing device 2 is inhibited (YES in S501), sector group access determiner 26 determines whether or not an access request from guest OS 8 is stored in sector group access information 32 (S502).

When an access request from guest OS 8 is stored in sector group access information 32 (YES in S502), sector group access determiner 26 determines that the access request from guest OS 8 is anomalous (S503). After that, the process of the flowchart of FIG. 11 ends.

When no access request from guest OS 8 is stored in sector group access information 32 (NO in S502), sector group access determiner 26 determines whether or not the timestamp of the access request falls within an expected first activation duration (such as one minute) (S504). When the timestamp of the access request does not fall within the first activation duration (NO in S504), sector group access determiner 26 determines that the access request is anomalous (S503). After that, the process of the flowchart of FIG. 11 ends.

On the other hand, when the timestamp of the access request falls within the first activation duration (YES in S504), sector group access determiner 26 determines that the behavior is a behavior permitted by the first behavior rule (S505). In this case, sector group access determiner 26 stores the access request from guest OS 8 in sector group access information 32. After that, the process of the flowchart of FIG. 11 ends.

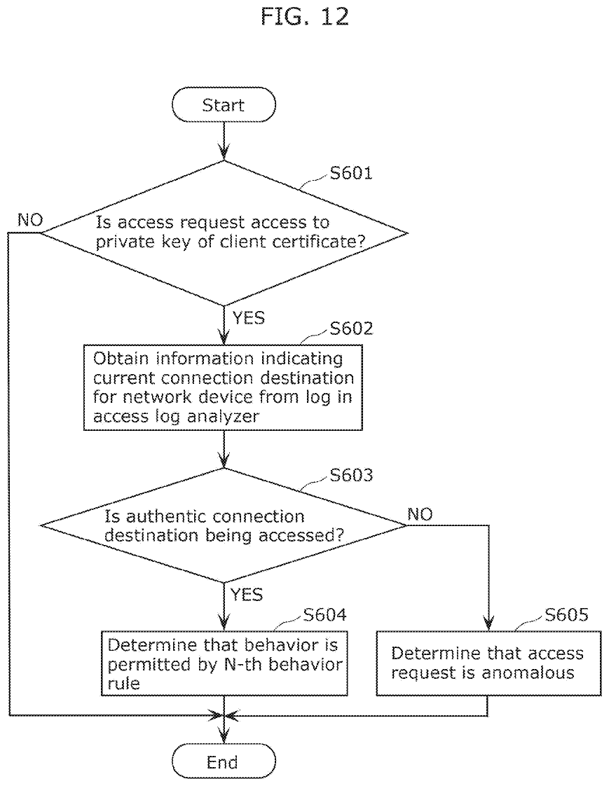

In the following, with reference to FIG. 12 to FIG. 19, various examples of a determination method for a behavior using the N-th behavior rule will be described.

First, with reference to FIG. 12, Example 1 of the determination method for a behavior using the N-th behavior rule will be described. FIG. 12 is a flowchart illustrating Example 1 of the determination method for a behavior using the N-th behavior rule. The N-th behavior rule is a rule concerning a behavior of an access to a private key of a client certificate, for example.

As illustrated in FIG. 12, sector group access determiner 26 determines whether or not the access request is a request for access to a private key of a client certificate (S601). When the access request is not a request for access to a private key of a client certificate (NO in S601), the process of the flowchart of FIG. 12 ends.

On the other hand, when the access request is a request for access to a private key of a client certificate (YES in S601), sector group access determiner 26 obtains information indicating a current connection destination for network device 11 from a log in access log analyzer 24 (S602). In this way, sector group access determiner 26 determines whether or not network device 11 that is an authentic connection destination is being accessed (that is, there is a request for the client certificate) (S603).

When network device 11 that is an authentic connection destination is being accessed (YES in S603), sector group access determiner 26 determines that the behavior is a behavior permitted by the N-th behavior rule (S604). After that, the process of the flowchart of FIG. 12 ends.

On the other hand, when network device 11 that is an authentic connection destination is not being accessed (NO in S603), sector group access determiner 26 determines that the access request is anomalous (S605). After that, the process of the flowchart of FIG. 12 ends.

In this way, sector group access determiner 26 determines whether or not the access request is anomalous by considering the state of network device 11. Therefore, when an attacker attempts to maliciously read a private key of a client certificate, sector group access determiner 26 can detect the attempt as an anomalous access req uest.

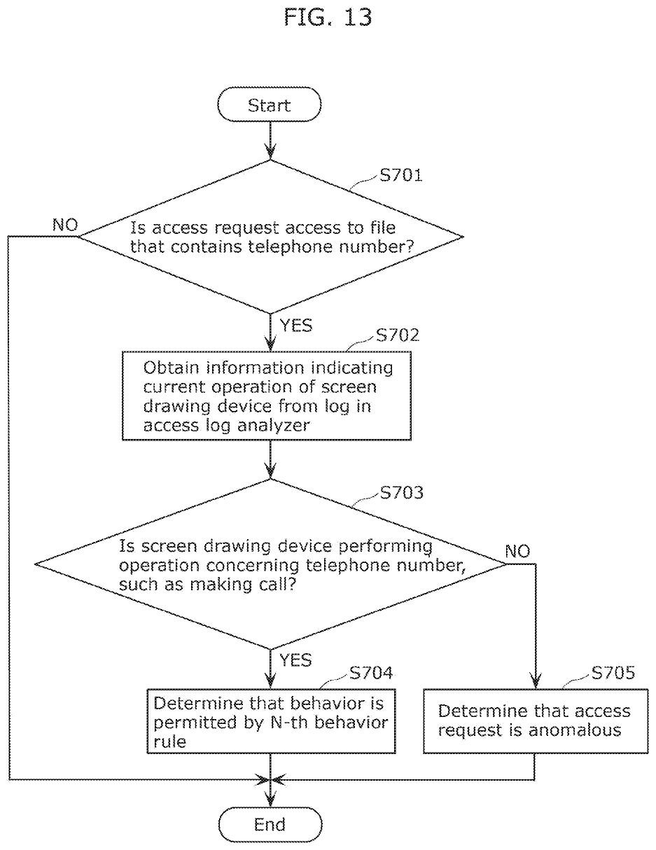

Next, with reference to FIG. 13, Example 2 of the determination method for a behavior using the N-th behavior rule will be described. FIG. 13 is a flowchart illustrating Example 2 of the determination method for a behavior using the N-th behavior rule. The N-th behavior rule is a rule concerning a behavior of an access to a file that contains a telephone number, for example.

As illustrated in FIG. 13, sector group access determiner 26 determines whether or not the access request is a request for access to a file that contains a telephone number (S701). When the access request is not a request for access to a file that contains a telephone number (NO in S701), the process of the flowchart of FIG. 13 ends.

On the other hand, when the access request is a request for access to a file that contains a telephone number (YES in S701), sector group access determiner 26 obtains information indicating a current operation of screen drawing device 13 from a log in access log analyzer 24 (S702). In this way, sector group access determiner 26 determines whether or not screen drawing device 13 is performing an operation concerning a telephone number, such as making a call (S703).

When screen drawing device 13 is performing an operation concerning a telephone number, such as making a call (YES in S703), sector group access determiner 26 determines that the behavior is a behavior permitted by the N-th behavior rule (S704). After that, the process of the flowchart of FIG. 13 ends.

On the other hand, when screen drawing device 13 is not performing an operation concerning a telephone number, such as making a call (NO in S703), sector group access determiner 26 determines that the access request is anomalous (S705). After that, the process of the flowchart of FIG. 13 ends.

In this way, sector group access determiner 26 determines whether or not the access request is anomalous by considering the state of screen drawing device 13. Therefore, when an attacker attempts to maliciously access a telephone number contained in a file stored in external storage device 12, sector group access determiner 26 can detect the attempt as an anomalous access request.

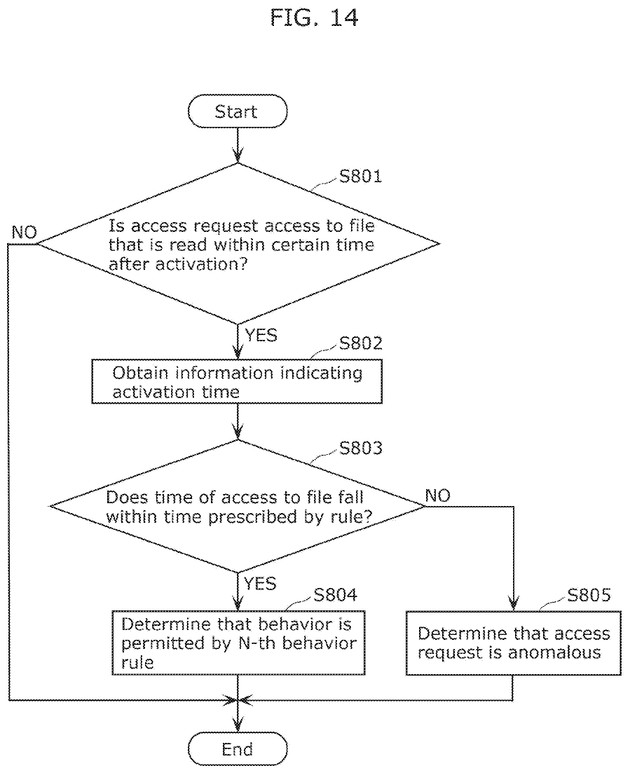

Next, with reference to FIG. 14, Example 3 of the determination method for a behavior using the N-th behavior rule will be described. FIG. 14 is a flowchart illustrating Example 3 of the determination method for a behavior using the N-th behavior rule. The N-th behavior rule is a rule concerning a behavior of an access to a file that is read within a certain time after activation of information processing device 2, for example.

As illustrated in FIG. 14, sector group access determiner 26 determines whether or not the access request is a request for access to a file that is read within a certain time after activation of information processing device 2 (S801). When the access request is not a request for access to a file that is read within a certain time after activation of information processing device 2 (NO in S801), the process of the flowchart of FIG. 14 ends.

On the other hand, when the access request is a request for access to a file that is read within a certain time after activation of information processing device 2 (YES in S801), sector group access determiner 26 obtains information indicating the activation time of information processing device 2 (S802). In this way, sector group access determiner 26 determines whether or not the time of access to the file falls within the time prescribed by the rule (that is, within the certain time after activation of information processing device 2) (S803).

When the time of access to the file falls within the time prescribed by the rule (YES in S803), sector group access determiner 26 determines that the behavior is a behavior permitted by the N-th behavior rule (S804). After that, the process of the flowchart of FIG. 14 ends.

On the other hand, when the time of access to the file does not fall within the time prescribed by the rule (NO in S803), sector group access determiner 26 determines that the access request is anomalous (S805). After that, the process of the flowchart of FIG. 14 ends.

In this way, sector group access determiner 26 determines whether or not the access request is anomalous by considering the state of information processing device 2. Therefore, when an attacker attempts to maliciously read a file (such as a kernel module or an initialization file) that must be read within a certain time after activation of information processing device 2 after the certain time after activation of information processing device 2, sector group access determiner 26 can detect the attempt as an anomalous access request.

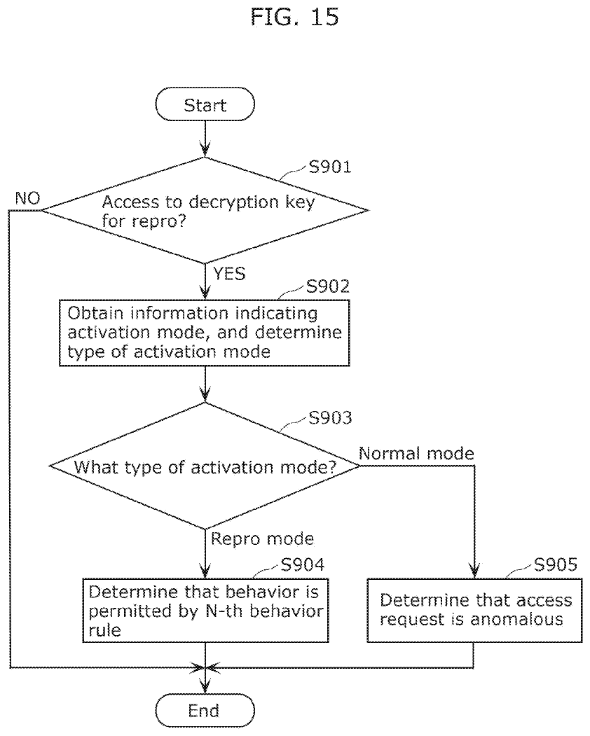

Next, with reference to FIG. 15, Example 4 of the determination method for a behavior using the N-th behavior rule will be described. FIG. 15 is a flowchart illustrating Example 4 of the determination method for a behavior using the N-th behavior rule. The N-th behavior rule is a rule concerning a behavior of an access to a decryption key for repro (program rewrite processing). The decryption key for repro is a file that is read only when information processing device 2 is activated in the repro mode in order to perform system update of information processing device 2.

As illustrated in FIG. 15, sector group access determiner 26 determines whether or not the access request is a request for access to a decryption key for repro (S901). When the access request is not a request for access to a decryption key for repro (NO in S901), the process of the flowchart of FIG. 15 ends. In a similar use case, whether or not the sector region to which a write is to be performed is a sector region for repro may also be determined. In that case, whether the access is normal or anomalous may be determined based on step S902 and the subsequent process.

On the other hand, when the access request is a request for access to a decryption key for repro (YES in S901), sector group access determiner 26 obtains information indicating the activation mode of information processing device 2, and determines the type of the obtained activation mode (the normal mode or the repro mode) (S902).

When the type of the activation mode is the repro mode (“repro mode” in S903), sector group access determiner 26 determines that the behavior is a behavior permitted by the N-th behavior rule (S904). After that, the process of the flowchart of FIG. 15 ends.

On the other hand, when the type of the activation mode is the normal mode (“normal mode” in S903), sector group access determiner 26 determines that the access request is anomalous

(S905). After that, the process of the flowchart of FIG. 15 ends.

In this way, sector group access determiner 26 determines whether or not the access request is anomalous by considering the state of information processing device 2. Therefore, when an attacker attempts to maliciously access a decryption key for repro to obtain information about the private key when information processing device 2 is activated in the normal mode, sector group access determiner 26 can detect the attempt as an anomalous access req uest.

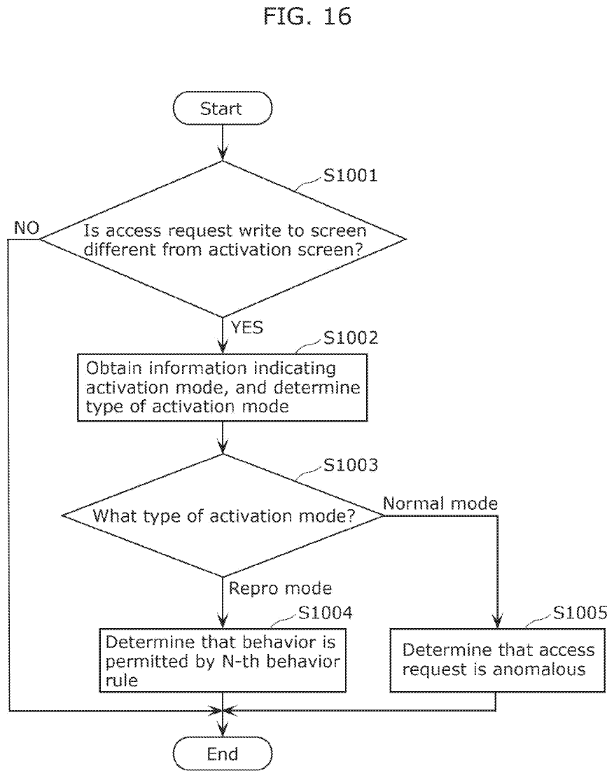

Next, with reference to FIG. 16, Example 5 of the determination method for a behavior using the N-th behavior rule will be described. FIG. 16 is a flowchart illustrating Example 5 of the determination method for a behavior using the N-th behavior rule. The N-th behavior rule is a rule concerning a behavior of a write to a screen different from an activation screen, for example. A write to a screen different from the activation screen occurs only when information processing device 2 is activated in the repro mode.

As illustrated in FIG. 16, sector group access determiner 26 determines whether or not the access request is a request for write to a screen different from the activation screen (S1001). When the access request is not a request for write to a screen different from the activation screen (NO in S1001), the process of the flowchart of FIG. 16 ends.

On the other hand, when the access request is a request for write to a screen different from the activation screen (YES in S1001), sector group access determiner 26 obtains information indicating the activation mode of information processing device 2, and determines the type of the obtained activation mode (the normal mode or the repro mode) (S1002).

When the type of the activation mode is the repro mode (“repro mode” in S1003), sector group access determiner 26 determines that the behavior is a behavior permitted by the N-th behavior rule (S1004). After that, the process of the flowchart of FIG. 16 ends.

On the other hand, when the type of the activation mode is the normal mode (“normal mode” in S1003), sector group access determiner 26 determines that the access request is anomalous (S1005). After that, the process of the flowchart of FIG. 16 ends.

In this way, sector group access determiner 26 determines whether or not the access request is anomalous by considering the state of information processing device 2. Therefore, when an attacker attempts to maliciously rewrite firmware by performing a write to a screen to which no write should be performed in the normal mode or forcedly activate a screen rewritten by forced rollback, sector group access determiner 26 can detect the attempt as an anomalous access request.

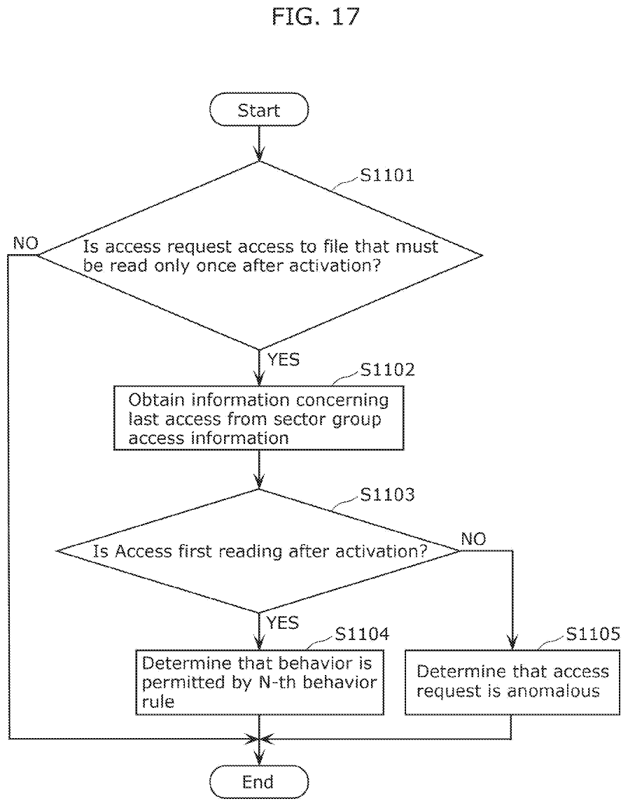

Next, with reference to FIG. 17, Example 6 of the determination method for a behavior using the N-th behavior rule will be described. FIG. 17 is a flowchart illustrating Example 6 of the determination method for a behavior using the N-th behavior rule.

The N-th behavior rule is a rule concerning a behavior of an access to a file that must be read only once after activation of information processing device 2, for example.

As illustrated in FIG. 17, sector group access determiner 26 determines whether or not the access request is a request for access to a file that must be read only once after activation of information processing device 2 (S1101). When the access request is not a request for access to a file that must be read only once after activation of information processing device 2 (NO in S1101), the process of the flowchart of FIG. 17 ends.

On the other hand, when the access request is a request for access to a file that must be read only once after activation of information processing device 2 (YES in S1101), sector group access determiner 26 obtains information indicating the last access from sector group access information 32 (S1102). In this way, sector group access determiner 26 determines whether or not the access to the file that must be read only once after activation of information processing device 2 is the first reading after activation of information processing device 2 (S1103).

When the access to the file that must be read only once after activation of information processing device 2 is the first reading after activation of information processing device 2 (YES in S1103), sector group access determiner 26 determines that the behavior is a behavior permitted by the N-th behavior rule (S1104). After that, the process of the flowchart of FIG. 17 ends.

On the other hand, when the access to the file that must be read only once after activation of information processing device 2 is not the first reading after activation of information processing device 2 (NO in S1103), sector group access determiner 26 determines that the access request is anomalous (S1105). After that, the process of the flowchart of FIG. 17 ends.

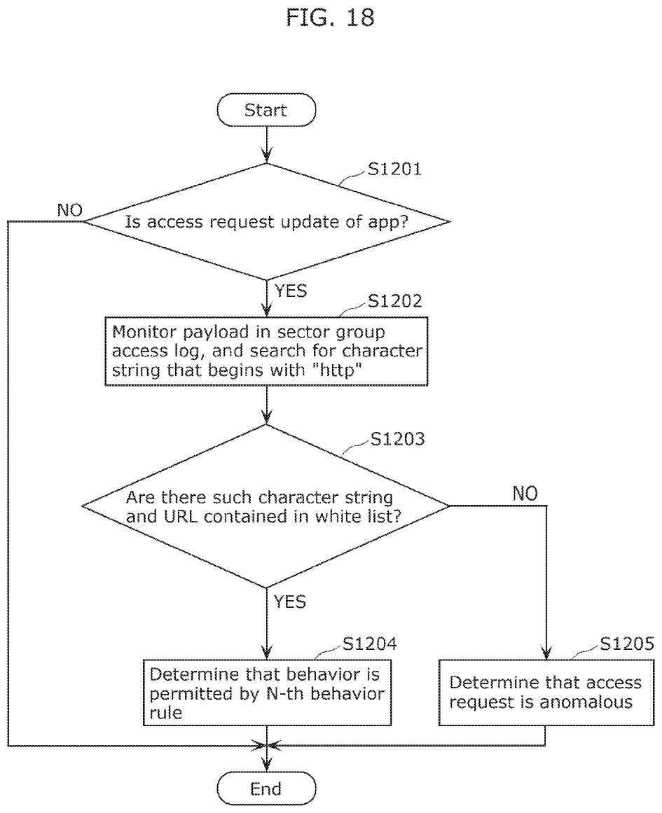

In this way, sector group access determiner 26 determines whether or not the access request is anomalous by considering the state of a file (sector group). Therefore, when an attacker attempts to maliciously read a file that will be read only once after activation of information processing device 2 (such as a configuration file for the first activation) and spy the initial configuration of information processing device 2, sector group access determiner 26 can detect the attempt as an anomalous access request. Next, with reference to FIG. 18, Example 7 of the determination method for a behavior using the N-th behavior rule will be described. FIG. 18 is a flowchart illustrating Example 7 of the determination method for a behavior using the N-th behavior rule. The N-th behavior rule is a rule concerning a behavior of an update of an application (referred to as an app hereinafter), for example.

As illustrated in FIG. 18, sector group access determiner 26 determines whether or not the access request is a request for update of an app (S1201). When the access request is not a request for update of an app (NO in S1201), the process of the flowchart of FIG. 18 ends.

On the other hand, when the access request is a request for update of an app (YES in S1201), sector group access determiner 26 monitors the payload in sector group access log 38, and searches for a character string that begins with “http” (S1202).

When there is such a character string (a character string that begins with “http”) in the payload in sector group access log 38, and the payload contains a uniform resource locator (URL) contained in a white list (YES in S1203), sector group access determiner 26 determines that the behavior is a behavior permitted by the N-th behavior rule (S1204). After that, the process of the flowchart of FIG. 18 ends.

On the other hand, when there is not such a character string in the payload in sector group access log 38, or the payload contains no URL contained in a white list (NO in S1203), sector group access determiner 26 determines that the access request is anomalous (S1205). After that, the process of the flowchart of FIG. 18 ends.

In this way, sector group access determiner 26 determines whether or not the access request is anomalous by considering the content of the access to a sector group to which a write is permitted. Therefore, when an attacker attempts to maliciously write an external URL that is not permitted (such as the URL of a C&C server) to a sector group by masquerading as an authentic app update, sector group access determiner 26 can detect the attempt as an anomalous access request.

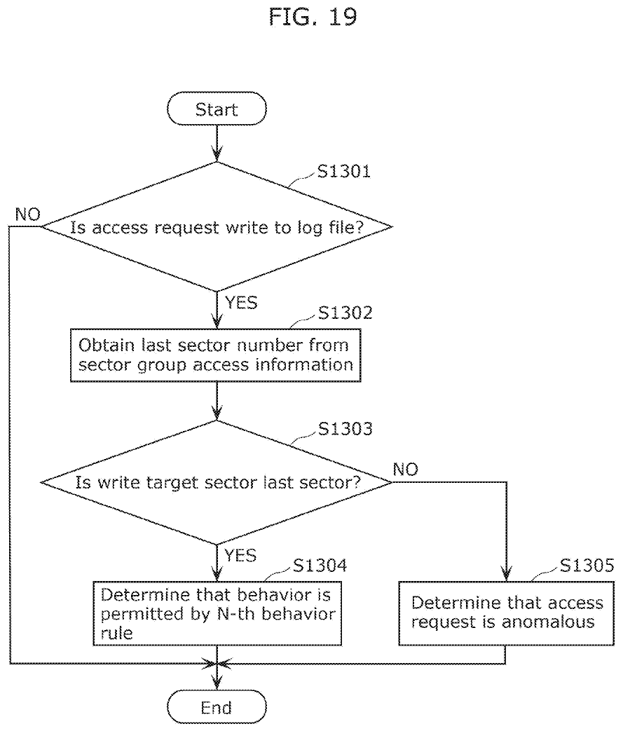

Next, with reference to FIG. 19, Example 8 of the determination method for a behavior using the N-th behavior rule will be described. FIG. 19 is a flowchart illustrating Example 8 of the determination method for a behavior using the N-th behavior rule. The N-th behavior rule is a rule concerning a behavior of a write to a log file, for example. A write is performed only to the last sector of the log file (that is, only an appending occurs).

As illustrated in FIG. 19, sector group access determiner 26 determines whether or not the access request is a request for write to a log file (S1301). When the access request is not a request for write to a log file (NO in S1301), the process of the flowchart of FIG. 19 ends.

On the other hand, when the access request is a request for write to a log file (YES in S1301), sector group access determiner 26 obtains the last sector number from sector group access information 32 (S1302). In this way, sector group access determiner 26 determines whether or not the write target sector is the last sector (S1303).

When the right target sector is the last sector (YES in S1303), sector group access determiner 26 determines that the behavior is a behavior permitted by the N-th behavior rule (S1304). After that, the process of the flowchart of FIG. 19 ends.

On the other hand, when the write target sector is not the last sector (NO in S1303), sector group access determiner 26 determines that the access request is anomalous (S1305). After that, the process of the flowchart of FIG. 19 ends.

In this way, sector group access determiner 26 determines whether or not the access request is anomalous by considering the content of the access to a sector group to which a write is permitted. Therefore, when an attacker attempts to maliciously perform a write to a sector other than the last sector of a log file in order to tamper a middle part of the log where a trace of the attack is left to erase the trace, sector group access determiner 26 can detect the attempt as an anomalous access request.

[3. Effect]

According to this embodiment, the authenticity of an access request from guest OS 8 is determined by host OS 10 hooking the access request and analyzing the hooked access request. Therefore, even when access control function 16 of guest OS 8 is disabled or tampered by a malicious computer program, for example, the access request hooked by host OS 10 can be used as information for monitoring any anomaly in guest OS 8, and the authenticity of the access request from guest OS 8 can be precisely determined.

### Other Embodiments

Although the information processing device and the determination method according to one or more aspects of the present disclosure have been described based on an embodiment, the present disclosure is not limited to the embodiment. Those skilled in the art will readily appreciate that embodiments arrived at by making various modifications to the above embodiment or embodiments arrived at by selectively combining elements disclosed in the above embodiment without materially departing from the scope of the present disclosure may be included within one or more aspects of the present disclosure.

Each of the elements in each of the above embodiments may be configured in the form of an exclusive hardware product, or may be realized by executing a software program suitable for the element. Each of the elements may be realized by means of a program executing unit, such as a Central Processing Unit (CPU) or a processor, reading and executing the software program recorded on a recording medium such as a hard disk or semiconductor.

In the above embodiment, the hypervisor (Type 1) is used as the virtualization control system. However, the virtualization control system is not limited to this, and an application (Type 2) including a hypervisor operated on a certain operating system may be adopted.

It should also be noted that a part or all of the functions in the information processing device may be implemented by executing a program by a processor such as a central processing unit (CPU).

It should also be noted that a part or all of the constituent elements included in each device described above may be implemented into an Integrated Circuit (IC) card or a single module which is attachable to and removable from the device. The IC card or the module is a computer system including a microprocessor, a ROM, a RAM, and the like. The IC card or the module may include the above-described super multi-function LSI. The microprocessor operates according to the computer program to cause the IC card or the module to execute its functions. The IC card or the module may have tamper resistance.

The present disclosure may be the above-described method. The method may be a computer program executed by a computer, or digital signals forming the computer program. The present disclosure may be a computer-readable recording medium on which the computer program or the digital signals are recorded. Examples of the computer-readable recording medium are a flexible disk, a hard disk, a Compact Disc-Read Only Memory (CD-ROM), a magnetooptic disk (MO), a Digital Versatile Disc (DVD), a DVD-ROM, a DVD-RAM, a BD (Blu-ray® Disc), and a semiconductor memory. The present disclosure may be the digital signals recorded on the recording medium. The present disclosure may be implemented by transmitting the computer program or the digital signals via an electric communication line, a wired or wireless communication line, a network represented by the Internet, data broadcasting, and the like. The present disclosure may be a computer system including a microprocessor and a memory. The memory stores the computer program and the microprocessor operates according to the computer program. It is also possible that the program or the digital signals may be recorded onto the recording medium to be transferred, or may be transmitted via a network or the like, so that the program or the digital signals can be executed by a different independent computer system. While the embodiment has been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims are incorporated herein by reference in their entirety: Japanese Patent Application No. 2021-198989 filed on December 8, 2021.

### INDUSTRIAL APPLICABILITY

The information processing device according to the present disclosure can be applied to a vertical ECU or the like that has a function of detecting an anomaly in a communication between VMs, for example.

1. An information processing device that determines an anomalous access to a vehicle, the information processing device comprising:
a first operating system;
a second operating system that accesses a sector group stored in a storage device, in response to an access request from the first operating system; and
a virtualization control system that is executed on a processor and controls execution of the first operating system and the second operating system, wherein
the second operating system includes:
an obtainer that obtains the access request from the first operating system; and
a determiner that determines whether or not the access request is anomalous, based on rule information indicating a rule for accessing the sector group stored in the storage device.

2. The information processing device according to claim 1, wherein
the second operating system further includes
an analyzer that generates, from the access request including (i) a sector number and (ii) a sector group name of the sector group stored in a storage area corresponding to the sector number in the storage device, access log information indicating the sector number and the sector group name in association with each other, with reference to correspondence information indicating a correspondence between the sector number and the sector group name, and
the determiner determines whether or not the access request is anomalous, based on the rule information and the access log information.

3. The information processing device according to claim 1, wherein
the second operating system further includes
a handler that sends, to an outside, a notification indicating a result of the determination made by the determiner, when the determiner determines that the access request is anomalous.

4. The information processing device according to claim 3, wherein
when the determiner determines that the access request is anomalous, the handler sends the notification to the outside and stops an access to the sector group stored in the storage device.

5. The information processing device according to claim 1, wherein
the rule information includes, as the rule, at least one of a process or an operation in which access to the sector group stored in the storage device is permitted.

6. The information processing device according to claim 1, wherein
the determiner determines whether or not the access request is anomalous, based on the rule information on reading and writing authority for reading and writing the sector group.

7. The information processing device according to claim 1, wherein
the second operating system is accessible to an external device, and
the determiner determines whether or not the access request is anomalous, based on the rule information and a state of the external device.

8. The information processing device according to claim 1, wherein
the determiner determines whether or not the access request is anomalous, based on the rule information and a state of the information processing device.

9. The information processing device according to claim 1, wherein
the determiner determines whether or not the access request is anomalous, based on the rule information and a state of the sector group.

10. The information processing device according to claim 1, wherein
the determiner determines whether or not the access request is anomalous, based on the rule information and an access content of an access to the sector group to which writing is permitted.

11. A determination method of determining an anomalous access to a vehicle, by using an information processing device,
the information processing device including:
a first operating system;
a second operating system that accesses a sector group stored in a storage device, in response to an access request from the first operating system; and
a virtualization control system that is executed on a processor and controls execution of the first operating system and the second operating system,
the determination method comprising:
obtaining, by the second operating system, the access request from the first operating system;
determining whether or not the access request obtained in the obtaining is anomalous, based on rule information indicating a rule for accessing the sector group stored in the storage device; and
outputting, to an outside, a result of the determining when the access request is determined to be anomalous. 1
